(19) United States
(12) Patent Application Publication
(10) Pub. No.: US 2014/0236552 A1
(43) Pub. Date: Aug. 21, 2014

(54) ENVIRONMENTAL TEST CHAMBER FOR WIRELESS SENSOR NETWORKS

(71) Applicant: UMM AL-QURA UNIVERSITY, Makkah (SA)

(72) Inventor: EMAD A. FELEMBAN, MAKKAH (SA)

(73) Assignee: UMM AL-QURA UNIVERSITY, MAKKAH (SA)

(21) Appl. No.: 13/772,263

(22) Filed: Feb. 20, 2013

(51) Int. Cl. G06F 17/50

(52) U.S. Cl. CPC G06F 17/5009
USPC 703/6

(57) ABSTRACT

The environmental test chamber for wireless sensor networks includes a structural enclosure having peripheral walls. A dynamic topology builder is a hanging mechanism disposed in a ceiling portion of the structure and is used to suspend the wireless devices below the ceiling portion via a cable. A weather conditioning machine simulating environmental conditions is disposed in at least one of peripheral walls. A controller sends commands to control the suspension height of the wireless units and to control environmental parameters of the weather conditioning machine. This allows the test chamber to test the communication and networking aspects of the wireless sensor network devices in different environmental conditions, such as sand storms and different temperatures, and humidity levels, within a 3-D topology specified by the controller.

### BACKGROUND OF THE INVENTION

1. Field of the Invention

The present invention relates to environmental testing devices, and particularly to an environmental test chamber for wireless sensor networks.

2. Description of the Related Art

Performance of wireless communication and networking depends on weather conditions, interference from other wireless devices and structural shapes that affect the signal reception. Many wireless technologies are now being used in harsh outdoor environments, affecting their performance in terms of data rate and reliability.

The increased use of the Wireless Sensor Network (WSN) in mission critical applications requires that platforms and protocols associated with this type of WSN should be designed with very high reliability. It has been shown in the literature that reliability studies in WSN don't exceed 5% of the overall literature discussing WSN. Most of the proposed wireless communication and networking protocols for WSN were developed starting from a simulation study with near ideal environmental conditions or inaccurate environmental models. Once this protocol is deployed in a real environment, its performance becomes questionable under real and harsh environmental conditions. It would be much better, however, if we could test the developed protocol in a situations similar to the real harsh environment, including severe sand storms, rain storms, mist or fog, wind, and the availability of water bodies.

Thus, an environmental test chamber for wireless sensor networks solving the aforementioned problems is desired.

### SUMMARY OF THE INVENTION

The environmental test chamber for wireless sensor networks includes a structural enclosure having peripheral walls. The chamber has a dynamic topology builder, which is a hanging mechanism disposed in a ceiling portion of the structure that is used to suspend the wireless devices below the ceiling portion via a cable. A weather conditioning machine mimicking environmental conditions is disposed in at least one of peripheral walls. A controller sends commands to control the suspension height of the wireless units and to control environmental parameters of the weather conditioning machine. This allows the test chamber to test the communication and networking aspects of the wireless sensor network devices in different environmental conditions, such as sand storms and different temperatures and humidity levels, within a 3-D topology specified by the controller.

These and other features of the present invention will become readily apparent upon further review of the following specification and drawings.

### BRIEF DESCRIPTION OF THE DRAWINGS

FIG. 1 is a diagrammatic perspective view of an environmental test chamber for wireless sensor networks according to the present invention, showing the testing chamber with dynamic topology builder.

FIG. 2 is a perspective view of the dynamic topology builder of an environmental test chamber for wireless sensor networks according to the present invention, showing placement of the elevation motors.

Similar reference characters denote corresponding features consistently throughout the attached drawings.

### DETAILED DESCRIPTION OF THE PREFERRED EMBODIMENTS

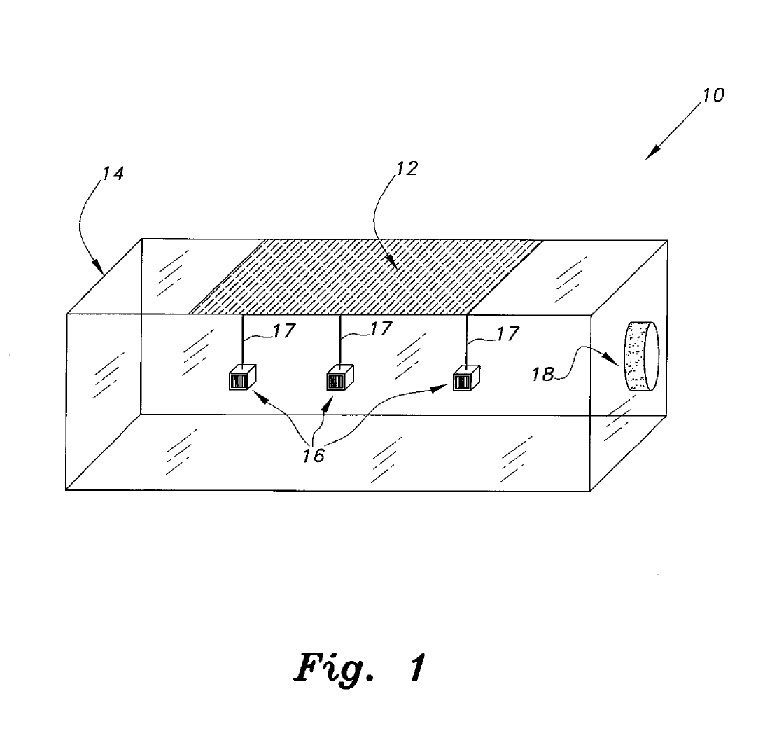

The environmental test chamber for wireless sensor networks is an apparatus for performing performance testing for wireless communication and networking aspects of wireless devices. The testing environment mimics sand storms, fog, smoke, mist, rain, and winds with different speed. It also allows the testing of communication and networking aspects for more than one sensor node with different settings and topologies. FIG. 1 shows a diagram of the proposed chamber, which contains three main components.

As shown in FIG. 1, the present testing chamber 10 includes a structural enclosure having peripheral walls 14. A dynamic topology builder 12, which is a hanging mechanism disposed in a ceiling portion of the chamber 10, is used to suspend the wireless devices 16 below the ceiling portion via cables 17. A weather conditioning machine 18 mimicking environmental conditions is disposed in at least one of the peripheral walls 14.

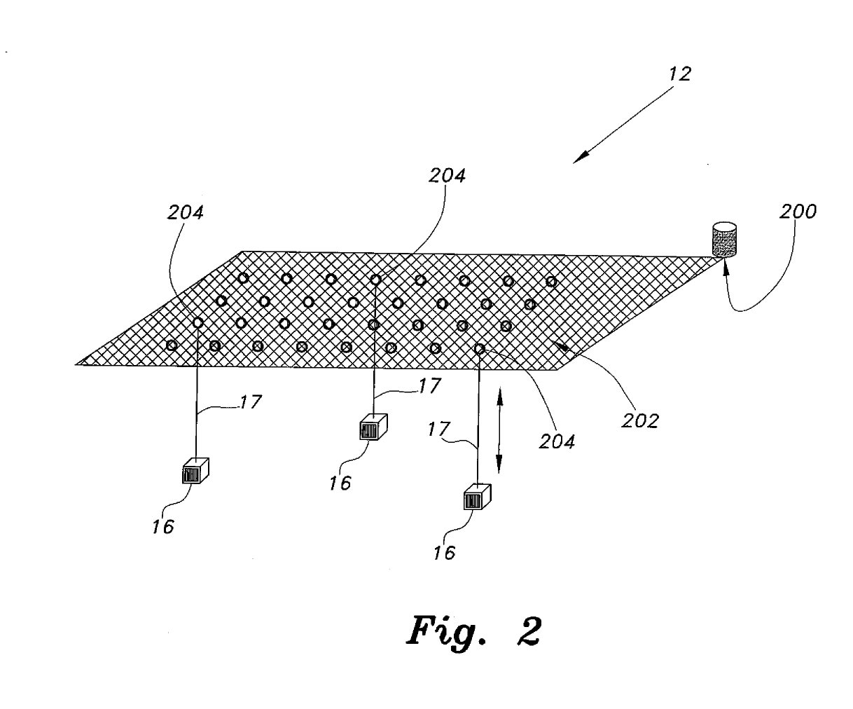

The present environmental test chamber 10 is scalable and can be room size, depending on the location and facilities, which will limit the population of the testing nodes inside the chamber. The wireless devices 16 can use any of a variety of wireless technologies. The dynamic topology builder 12 and the weather conditioner 18 are connected to a controller station 200 (shown in FIG. 2), which controls simulation of the environment and specific testing conditions under which the WSN devices 16 are exposed. As shown in FIG. 2, the controller 200 sits atop the intertwined net 202 of the topology builder 12. Elevation motors 204 are disposed at the various nodes defined by the intertwined net 202. The suspension cables 17 are connected to motors 204 or electric winches such that the wireless devices 16 can be raised or lowered as the motor 204 pays out or reels in the cables 17. As shown in FIG. 2, the nodes are configured in an X-Y plan. The elevation motors 204 are placed at each intersection of the intertwined structure 202, the hanging cable 17 controlling the elevation of the wireless devices 16 in the Z-plane. Thus, node placement within the intertwined net 202 defines an x-y-z topology builder. The elevation motors 204 control the cables 17 according to commands sent by the controller 200, which may be connected to a corresponding controller PC (personal computer) for doing the simulation. When a user wants to build a certain topology, the controller 200 will accept a topology description from, e.g., a PC, and the controller 200 actuates the respective elevation motors 204 to release or reel in the respective cables 17, thus disposing the wireless devices 16 at the required elevation in the Z-Axis.

The weather conditioner 18, shown in FIG. 1, conditions the testing chamber according to the testing scenario. The weather conditioner may inject sand to simulate sand storms (e.g., using a reservoir of sand and at least one blower motor); water to simulate rain storms (e.g., using a water reservoir, electronically controlled pump, and a sprinkler system); and may also adjust humidity (using a water heater and a fan, or an electronically controlled dehumidifier)), and temperature conditions (using an electronically controlled thermostat and HVAC.

It is to be understood that the present invention is not limited to the embodiments described above, but encompasses any and all embodiments within the scope of the following claims.

I claim:

1. An environmental test chamber for wireless sensor networks, comprising:
a chamber defined by peripheral walls, the chamber having a ceiling;
an intertwined net disposed in the ceiling of the chamber, the intertwined net defining nodes configured in an X-Y plan;
at least one cable;
a motor disposed in at least one of the nodes, the motor selectively paying out and reeling in the at least one cable to lower and raise the cable in a Z-axis direction, the at least one cable being adapted for suspending at least one energized wireless device therefrom inside the chamber;
a weather conditioner disposed in at least one of the peripheral walls, the weather conditioner having means for simulating user-selectable weather condition inside the chamber; and
a controller connected to the motor and to the weather conditioner, the controller being configured for sending commands to the motor responsive to user input to raise and lower the suspended energized wireless device and configured for sending commands to the weather conditioner responsive to user input to simulate selected weather conditions inside the chamber.

2. The environmental test chamber for wireless sensor networks according to claim 1, wherein said weather conditioner has means for responsively adjusting humidity in said chamber according to commands sent from said controller.

3. The environmental test chamber for wireless sensor networks according to claim 1, wherein said weather conditioner has means for responsively injecting water into said chamber according to commands sent from said controller to simulate a rain storm.

4. The environmental test chamber for wireless sensor networks according to claim 1, wherein said weather conditioner has means for responsively adjusting temperature conditions in said chamber according to commands sent from said controller.

5. The environmental test chamber for wireless sensor networks according to claim 1, wherein said at least one cable comprises a plurality of cables, the test chamber further comprising a plurality of energized wireless devices suspended from the plurality of cables inside of the chamber, the plurality of energized wireless devices constituting a wireless sensor network under test.
